(19) United States
(12) Patent Application Publication
(10) Pub. No.: US 2016/0272015 A1
(43) Pub. Date: Sep. 22, 2016

(54) AXLE VENT ASSEMBLY

(71) Applicant: Servitech Industries, Inc., Nashville, TN (US)

(72) Inventor: CLYDE G. STECH, Goodlettsville, TN (US)

(21) Appl. No.: 15/074,206

(22) Filed: Mar. 18, 2016

Related U.S. Application Data
(60) Provisional application No. 62/134,901, filed on Mar. 18, 2015.

(51) Int. Cl. B60C 23/00; B60B 35/00

(52) U.S. Cl. CPC B60C 23/00; B60B 35/00

(57) ABSTRACT

A vehicle tire inflation system including an axle, an axle housing having an axle cavity, and a single port extending through the axle housing. A y-fitting is coupled to the port, the y-fitting having a first passageway and a second passageway. At least one conduit extends in the axle cavity and fluidly couples the first passageway to the axle ends, wherein the second passageway is configured to vent a fluid in the axle cavity to exterior the axle. A y-connector may be positioned in the axle housing to distribute pressurized air received from the conduit to each of the axle ends.

### CROSS-REFERENCE TO RELATED APPLICATION(S) AND CLAIM OF PRIORITY

This application claims priority of U.S. Provisional Patent Application Ser. No. 62/134,901 filed Mar. 18, 2015 entitled Axle Vent Assembly, the teachings of which are incorporated herein by reference.

### TECHNICAL FIELD

This disclosure is related to a pneumatic vehicle axle suited to automatically inflate tires.

### BACKGROUND

Vehicle tire inflation systems typically include an air pressurization source, and conduits configured to route the pressurized air via an axle to tires rotatably attached to the axle. The conduits can be routed outside the axle, inside the axle, or the ax axle itself may be pressurized to form a conduit, and there are both benefits and drawbacks to these conventional systems.

Conduits that are routed outside the axle are subject to the environment, including dirt and debris, and can be easily damaged, but are readily available for servicing. Conduits that extend in the axle require numerous threaded holes to be formed through the axle housing, which is both time consuming and expensive. Typically, one conduit hole is formed in the axle housing for receiving pressurized air, and another conduit hole is formed in the axle housing for venting any air leaked in the axle. In another configuration, the axle itself may be pressurized to eliminate the need for conduits routing pressurized air. This approach has challenges including leakage of air, and coupling the air to rotating tires is more complex.

### SUMMARY

A vehicle tire inflation system including an axle, an axle housing having an axle cavity, and a single port extending through the axle housing. A y-fitting is coupled to the port, the y-fitting having a first passageway and a second passageway. At least one conduit extends in the axle cavity and fluidly couples the first passageway to the axle ends, wherein the second passageway is configured to vent a fluid in the axle cavity to exterior the axle. A y-connector may be positioned in the axle housing to distribute pressurized air received from the conduit to each of the axle ends.

### BRIEF DESCRIPTION OF THE FIGURES

FIG. 1 illustrates a side sectional view of a pneumatic vehicle axle configured to inflate tires and also vent air from within the axle if there is a leak, using only one port extending through the axle housing and a two passageway y-fitting, a pressure source, and a breather port;

FIG. 2 illustrates an enlarged view of the two passageway y-fitting of FIG. 1 configured to both deliver pressurized air to tires using an inner passageway coupled to an axle conduit assembly, and also vent air from within the axle using an outer passageway such as during a leak;

FIG. 3 illustrates a side view of the y-fitting and the tubing extending through the y-fitting for delivering pressurized air;

FIG. 4 illustrates a cross sectional view taken at 4-4 in FIG. 3 showing the inner and outer passageways;

FIG. 5 illustrates another embodiment of the disclosure showing a y-valve directly connected to one of the cylinder plugs without using tubing; and

FIG. 6 illustrates a side view of the y-valve of FIG. 5 that is configured to threadably connect to the cylinder plugs using tubing instead of quick-connects.

### DETAILED DESCRIPTION

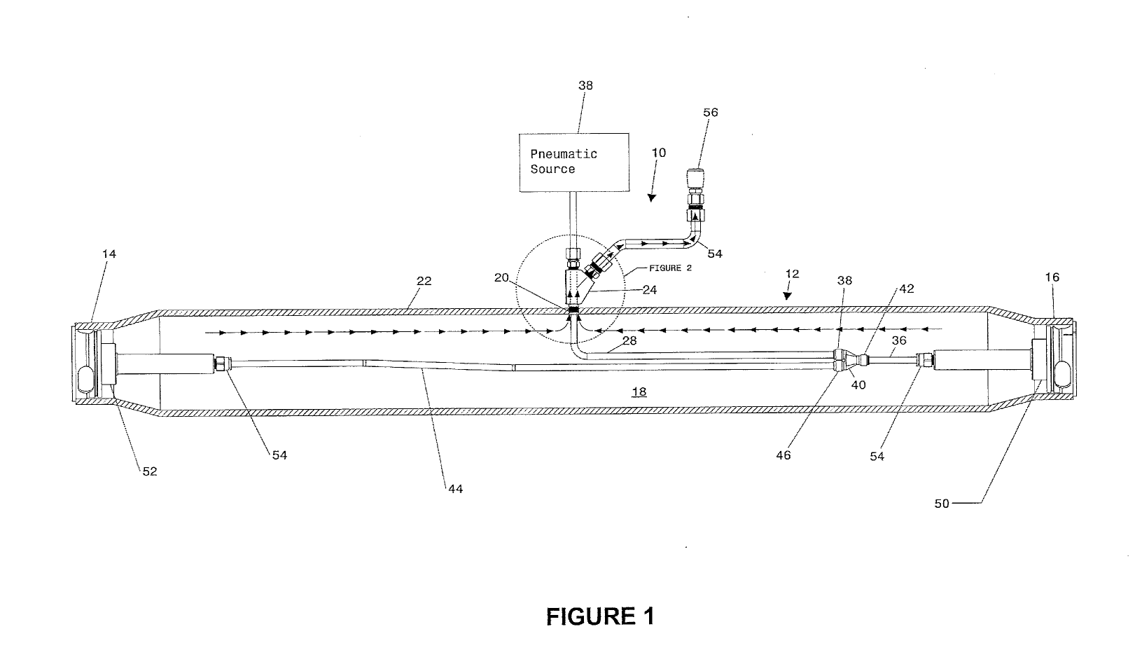

Referring to FIG. 1, there is shown a vehicle tire inflation system at 10. System 10 is seen to include an elongated vehicle axle 12, such as a car or truck axle, extending between a first end 14 including a driver side cylinder plug and a second end 16 including a curbside cylinder plug. Axle 12 has an axle housing 22 forming a cavity 18 that extends between the first end 14 and the second end 16. The axle housing 22 may be comprised of steel or other structurally sound materials as desired. Each of the axle ends 14 and 16 are configured to couple to a respective wheel having a tire (not shown) in a conventional manner.

Axle 12 is shown as a cross section and has a single threaded port 20 extending through the axle wall 22 of the axle 12. A fitting 24 has a first opening 25 threadably coupled to the threaded port 20 and has two fluid passageways.

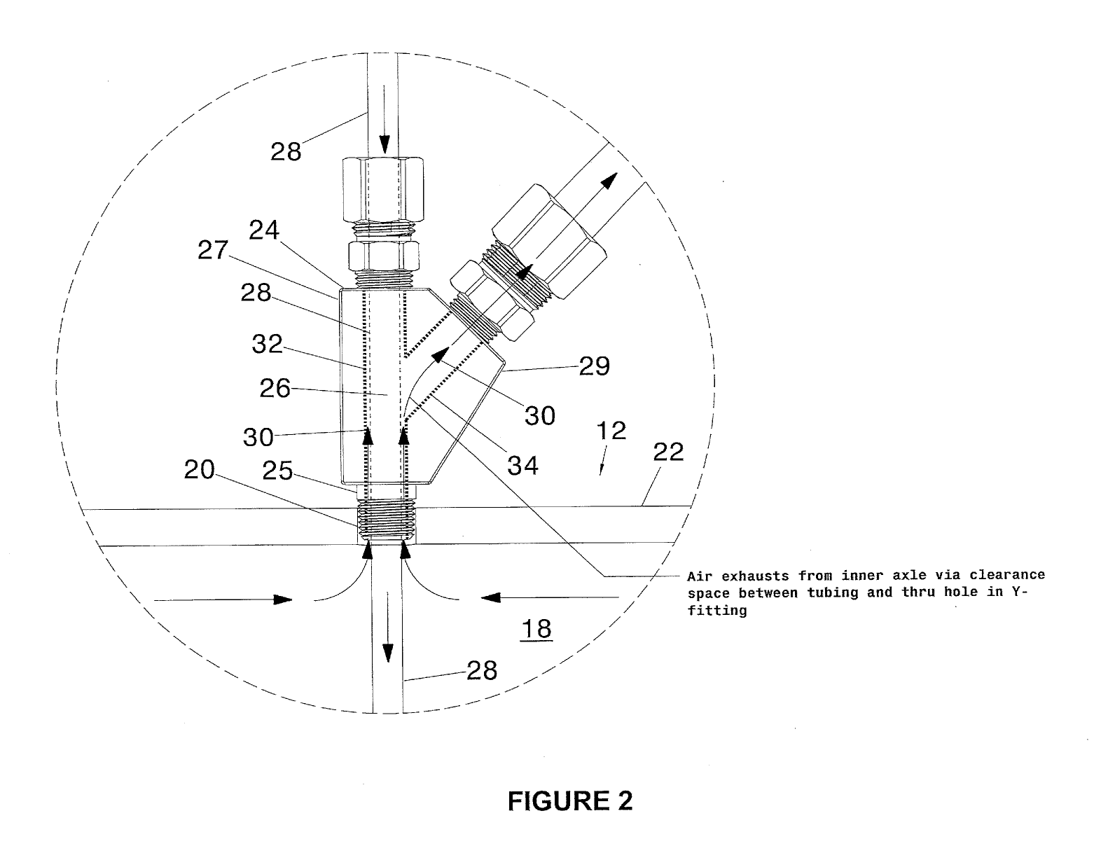

As illustrated in FIG. 2 showing an enlarged view of the fitting 24. A first inner fluid passageway 26 is defined by a tube 28 extending through the fitting 24 from outside the first opening 25 to a second opposing opening 27. The tube 28 extends through the second opening 27 and is configured to provide pressurized air from a pneumatic source 38 to each of the tires.

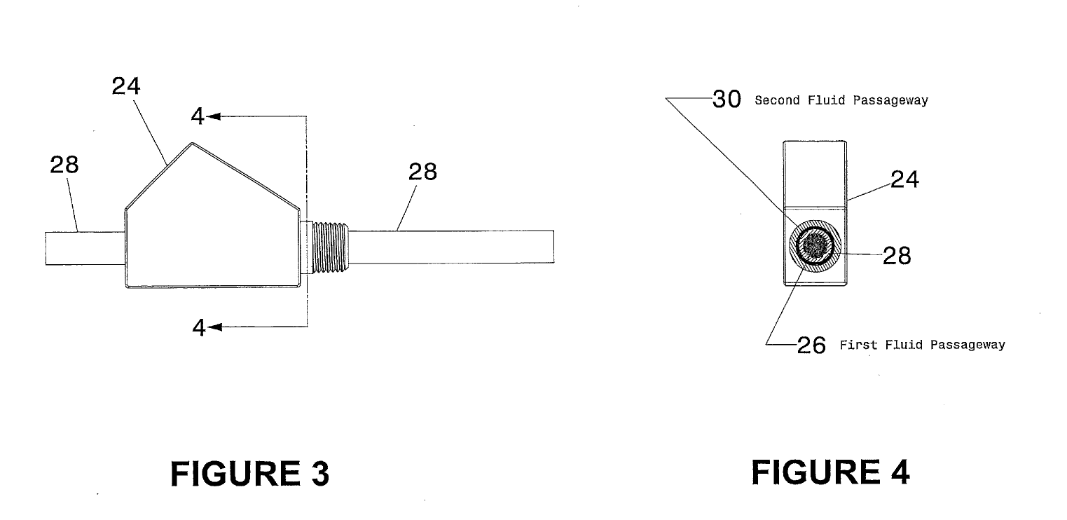

A second fluid passageway 30 is defined by an inner wall of the fitting 24 coaxially disposed about the tube 28 and extends from the first opening 25 to the second opening 27. The second passageway 30 terminates at the first opening 25, but extends through the second opening 27, as shown. The fitting 24 has a channel extending through the fitting, the channel having an inner wall 32 spaced from the outer surface of tube 28 extending through the fitting 24 to create a first portion of the second passageway, as shown. The second passageway 30 extends in a clearance space between tube 28 and inner wall 32, such that the tube 28 is coaxial with the first portion of the second passageway 30, as shown in FIGS. 3 and 4. The second passageway 30 also extends into a tubular branch 34 of the fitting 24 having a third opening 29 to create a second portion of the second passageway 30. The two portions of the second passageway 30 form a y-shape, with the second portion branching from the first portion. Other shapes of the second passageway 30 are possible, such as a t-shape. The shape of the fitting 24 can be a polygon as shown, but can be of any shape having the first and second passageways, such as a y-shape, a square, triangle, circle or sphere. The second passageway 30 extends through the port 20 and opens into the axle cavity 18, and is configured to exhaust any leaked air from the axle cavity 18, such as a rupture of the tube 28 or conduits extending in the axle cavity 18.

Referring to FIG. 1, the distal end of tube 28 extends through the first opening 25 of the fitting 24, exits the fitting 24, and then extends within the axle cavity 18 to a first end 38 of a y-connector 40 forming a splitter. Thus, a single tube 28 extends from the pressure source 38 directly to the y-connector 40. A conduit 36 is coupled to a second end 42 of the y-connector 40 and communicates a fluid from source 38 (via tube 28) to axle end 16, to pressurize the respective tire(s) (not shown) via the curbside cylinder plug 50. A conduit 44 is coupled to a third end 46 of the y-connector 40, and is coupled to end 14 to pressurize the respective tire(s) (not shown) via the driver side cylinder plug 52. Each end 38, 42 and 46 of the y-connector 40 may have a quick-connect. A connector 54, such as a quick-connect, provides a connection from the conduit 36 to the curbside cylinder plug 50, and from the conduit 44 to the driver's side cylinder plug 52.

Any fluid pressure within the cavity 18 of axle 12, such as caused by a leak of tube 28, conduit 36, conduit 44, y-connector 40, connectors 54, and/or the cylinder plugs 50 and 52, exhausts through the single port 20 via the second passageway 30 and the tubular branch 34, and via a conduit 54 coupled to a breather 56 that may be coupled to a vehicle frame (not shown). The breather 56 comprises a one direction valve, such as check valve comprising a nylon ball and a ½ lb. spring allowing leaked pressurized air in the axle cavity 18 to vent. The valve is configured to allow the venting of air at a very low pressure such that even a low pressure leak in the axle cavity will vent. The breather 56 also allows any lubricant in the axle cavity to vent with the air and not become blocked.

The fitting 24 allows only the single port 20 to be created through the axle wall 22, while providing a first passageway 28 to source a fluid to the axle ends 14 and 16, and a second passageway 30 to vent fluid pressure from within the axle cavity 18. This unique system and fitting reduces costs, complexity, and labor to install a tire inflation system to a vehicle.

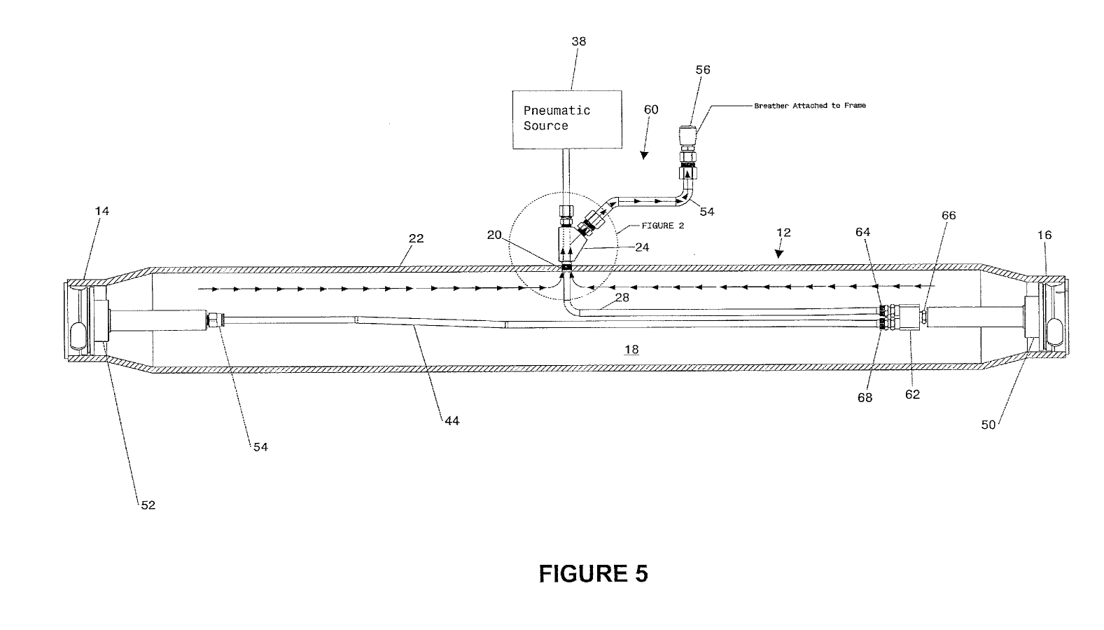

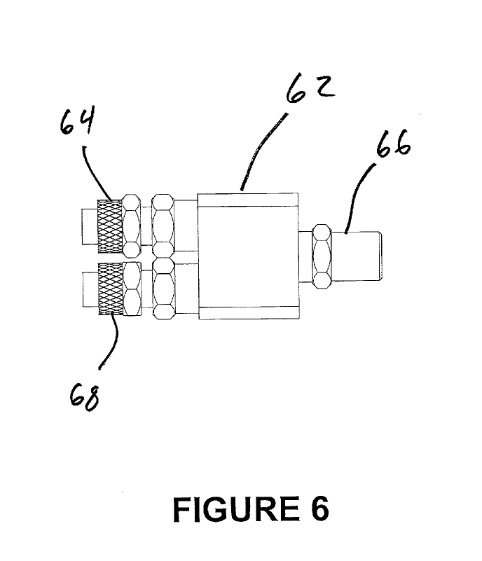

Referring to FIG. 5, there is shown another embodiment of the disclosure shown as system 60, wherein like numerals refer to like elements. In this embodiment, a y-connector 62 is positioned in the axle 12 and is directly coupled to the curbside cylinder plug 50 to remove a conduit therebetween, such as conduit 36. Further, the y-connector 62, as shown in FIG. 6, may have threaded connectors 64, 66 and 68 for pneumatically coupling to the tube 28, curbside cylinder plug 50 and conduit 44, respectively, such that the quick-connects are eliminated, and to provide a more robust pneumatic seal.

The fitting 24 is shown coupled to the threaded port 20 outside of the axle 12, but could reside in the axle 12 in another configuration if desired.

Though the invention has been described with respect to a specific preferred embodiment, many variations and modifications will become apparent to those skilled in the art upon reading the present application. The intention is therefore that the appended claims be interpreted as broadly as possible in view of the prior art to include all such variations and modifications.

1. A vehicle tire inflation system, comprising:
an axle having a first end and a second end, an axle housing and having an axle cavity in the axle housing, the axle having a port extending through the axle housing;
a fitting coupled to the port, the fitting having a first passageway and a second passageway; and
a first conduit extending in the axle cavity and fluidly coupling the fitting first passageway to the axle ends, wherein the fitting second passageway is configured to vent a fluid in the axle cavity to exterior the axle.

2. The system as specified in claim 1, wherein the second passageway has a first portion, and a second portion branching from the first portion.

3. The system as specified in claim 1, wherein the second passageway is at least partially adjacent the first passageway.

4. The system as specified in claim 1, wherein the second passageway at least partially encompasses the first passageway.

5. The system as specified in claim 4, wherein the first passageway comprises a tube extending through the fitting, and the second passageway extends along an exterior of the tube.

6. The system as specified in claim 5, wherein the fitting has a channel extending through the fitting, and the tube extends through the channel.

7. The system as specified in claim 6, wherein the channel has a y-shape including a first outlet, a second outlet and a third outlet.

8. The system as specified in claim 7, wherein the tube extends from the first outlet to the second outlet, and the third outlet is in fluid communication with the second passageway.

9. The system as specified in claim 1, further comprising a connector disposed in the axle cavity, wherein the conduit extends from the first passageway to a first end the connector, the connector having a second end fluidly coupled to a first axle end, and having a third end fluidly coupled to a second axle end.

10. The system as specified in claim 9, further comprising a second conduit fluidly coupled between the connector third end and the second axle end.

11. The system as specified in claim 10, further comprising a third conduit fluidly coupled between the connector second end and the first axle end.

12. The system as specified in claim 10, wherein the connector second end is directly coupled to the axle first end.

13. The system as specified in claim 10, wherein the connector is a y-connector having a quick-connect at each of the connector first end, second end and third end.

14. The system as specified in claim 10, wherein the connector has a threaded connector at each of the connector first end, second end and third end.

15. The system as specified in claim 9, wherein the conduit is a single tube extending through the first passageway and is connected to the connector first end.

16. A vehicle tire inflation system, comprising:
an axle having a first end and a second end, an axle housing, and an axle cavity in the axle housing, the axle having a port extending through the axle housing;
a fitting coupled to the port, the fitting having a first passageway and a second passageway;
a y-connector disposed in the axle cavity and having a first end, a second end fluidly coupled to a first axle end, and a third end fluidly coupled to a second axle end; and
a first conduit extending in the axle cavity and fluidly coupling the first passageway to the axle ends, wherein the second passageway is configured to vent a fluid in the axle cavity to exterior the axle.

17. The system as specified in claim 16, further comprising an air pressure source fluidly coupled to the first passageway.

18. The system as specified in claim 16, wherein the second passageway is at least partially adjacent the first passageway.

19. The system as specified in claim 18, wherein the second passageway encompasses the first passageway.

20. The system as specified in claim 19, wherein the first passageway comprises a tube extending through the fitting, and the second passageway extends along an exterior of the tube.
